(19) United States
(12) Patent Application Publication
(10) Pub. No.: US 2007/0117905 A1
(43) Pub. Date: May 24, 2007

(54) Thermoplastic resin composition and molded product from the same

(75) Inventors: Hideo Toyoda, Chiba-shi (JP); Hirotaka Uosaki, Ichihara-shi (JP)

Correspondence Address: BUCHANAN, INGERSOLL & ROONEY PC, POST OFFICE BOX 1404, ALEXANDRIA, VA, 22313-1404, US

(73) Assignee: Mitsui Chemicals, Inc., Minato-ku (JP)

(21) Appl. No.: 11/546,331

(22) Filed: Oct. 12, 2006

Related U.S. Application Data
(60) Provisional application No. 60/738,608, filed on Nov. 22, 2005.

(51) Int. Cl. C08J 3/22

(52) U.S. Cl. 524/487; 524/543

(57) ABSTRACT

A thermoplastic resin composition of the present invention comprises a thermoplastic resin (A), and
a polyolefin wax (B) having a number-average molecular weight (Mn), as measured by gel permeation chromatography (GPC), in the range of 400 to 5,000, a melting point, as measured by a differential scanning calorimetry (DSC), in the range of 65 to 130° C., and a density, as measured by a density gradient tube process, in the range of 850 to 980 kg/m³, and satisfying the relationship represented by the following formula (I) of the crystallization temperature (Tc(° C.), measured at a temperature lowering rate of 2° C./min.), as measured by a differential scanning calorimetry (DSC), and the density (D (kg/m³)):
   0.501×D−366≧Tc (I). The thermoplastic resin composition can reduce the load applied on the screw of an extruder upon plasticization, and has good extrusion productivity. A molded product of the present invention is obtained by molding the thermoplastic resin composition.

### BACKGROUND OF THE INVENTION

1. Field of the Invention

The present invention relates to a thermoplastic resin composition having good extrusion productivity and a molded product obtained by molding the composition.

2. Description of the Related Art

For the extrusion molding, vinyl chloride resins are widely used due to their good molding processibility. However, recently, there has been a desire of an alternative resin which is more environment-friendly than the vinyl chloride resins because of the problems regarding dioxin, acidic rain caused by the scattering of the acidic components by disposal of the vinyl chloride resins by means of burning, or others. Examples of candidates for the alternative resin include olefin resins such as polyethylene and polypropylene, and styrene resins such as polystyrene and an ABS resin. Further, improvement on the productivity in view of an economic aspect has been more strongly required, and correspondingly increase in the amount to be extruded upon molding has been also desired.

Among the above-described alternative resins, since the olefin resin is crystalline, it is difficult to mold the olefin resin due to its narrow range of the processing conditions for the extrusion molding or foam extrusion molding. When the polyolefin resin is melt-extruded at a discharge amount, deteriorated products of the polyolefin resin or a part of additives, or their oxidized products or decomposed products, which are also called as “resin deposits”, are generated on the extrusion side of the die, and adhered thereto. Thus, these “resin deposits” are adhered to the surface of the extruded molded article from the die, or they generate stripe-shaped concave-and-convex, or the like on the surface of the molded article, thus leading to deterioration of the quality of the molded article. Accordingly, in order to remove these “resin deposits” from the extrusion side of the die, additional labors such as temporarily stopping the molding and then cleaning up the extrusion side of the die were required, and thus as a result, it was difficult to promote the improvement on the productivity. For this reason, various methods have been proposed, including a method which comprises adding a metal soap such as magnesium stearate or a lubricant such as stearic acid amide to the polyolefin resin to be melt-extruded, so as to improve the sliding property with the wall of the die, and thus to prevent the generation of the “resin deposits”. However, the method which comprises adding a metal soap such as magnesium stearate or a lubricant such as stearic acid amide to the polyolefin resin to be melt-extruded in order to improve the sliding property with the wall of the die is less effective in the improvement, and furthermore, since it involves the addition of the lubricant, there exist problems such as reduced thermal adhesiveness upon molding, and adverse effect on the functions of the additives which have been blended for the improvement on the physical properties, such as the anti-static property or the anti-blocking property, of the molded article.

On the other hand, the styrene resin is a non-crystalline resin, and thus it is relatively easily capable of extrusion molding or foam extrusion molding, as compared with the olefin resin. However, it is pointed out that the rubber modified thermoplastic resin such as the ABS resin, when subjected to extrusion molding, is applied with a larger load on the screw of an extruder upon plasticization in a cylinder, as compared with the vinyl chloride resin, and it does not allow increase in the discharge amount, thus leading to a low productivity. Further, it is thought that in order to prevent the molten resin flown from the die upon extrusion molding from generating sagging or deformation, or in order to prevent the foam cell upon foam extrusion molding from being broken, a higher melt tension of the molten resin is favorable. It is a well-known fact that it is preferable that a high molecular weight component is incorporated in the resin for the purpose of enhancing the melt tension. For example, as described in JP-A No. 47-35040, a high molecular weight component is added to improve the processibility and the surface of the molded article. However, when the molecular weight of the resin is increased or a larger amount of the high molecular weight component is added for the purpose of enhancing the melt tension, the fluidity is lowered, and excessive load is applied on the extruder upon molding. Further, when the spinning rate is decreased to avoid the excessive load applied, the discharging is lowered, thus leading to a problem of lower productivity. Further, generally, in order to increase the impact resistance of a resin, the increase in the molecular weight of the resin has been carried out as a material design. Such the increase in the impact resistance is thought to be caused from the increased entanglement between the polymers, but this also leads to a problem of a load on the extruder.

### SUMMARY OF THE INVENTION

It is an object of the present invention to provide a thermoplastic resin having good extrusion productivity by reducing the load applied on the screw of an extruder upon plasticization and a molded product obtained by molding the resin.

The present inventors have earnestly studied to overcome the above-described problems, and as a result, they have found that the discharging can be remarkably improved upon extrusion molding or foam extrusion molding by adding a specific polyolefin wax to a thermoplastic resin. The finding leads to completion of the present invention.

Specifically, the present invention relates to:

[1] a thermoplastic resin composition comprising

a thermoplastic resin (A), and

a polyolefin wax (B) having a number-average molecular weight (Mn), as measured by gel permeation chromatography (GPC), in the range of 400 to 5,000, a melting point, as measured by a differential scanning calorimetry (DSC), in the range of 65 to 130° C., and a density, as measured by a density gradient tube process, in the range of 850 to 980 kg/m³, and satisfying the relationship represented by the following formula (I) of the crystallization temperature (Tc(° C.), measured at a temperature lowering rate of 2° C./min.), as measured by a differential scanning calorimetry (DSC), and the density (D (kg/m³)):
0.501×D−366≧Tc (I);

[2] the thermoplastic resin composition in which the polyolefin wax (B) is contained in an amount of 0.1 to 20 parts by weight based on 100 parts by weight of the thermoplastic resin;

[3] the thermoplastic resin composition, wherein the thermoplastic resin (A) comprises at least one resin selected from the group consisting of a polyolefin resin, an olefin-vinyl compound copolymer, a polyvinyl resin, a polystyrene resin, a polyester resin and a polyamide resin;

[4] the thermoplastic resin composition, wherein the thermoplastic resin (A) is a blend of the resins selected from the group consisting of a polyolefin resin, an olefin-vinyl compound copolymer, a polyvinyl resin, a polystyrene resin, a polyester resin and a polyamide resin;

[5] the thermoplastic resin composition, wherein the thermoplastic resin (A) comprises at least on copolymer selected from the group consisting of a graft copolymer, a block copolymer and a random copolymer;

[6] the thermoplastic resin composition, wherein the thermoplastic resin (A) is a blend of the copolymers selected from the group consisting of a graft copolymer, a block copolymer and a random copolymer; and

[7] a molded product obtained by molding the thermoplastic resin composition, which is in the form of a film or a sheet.

By using the above-mentioned polyolefin wax (B), the load applied on the screw of an extruder can be reduced upon plasticization of a thermoplastic resin, and thus extrusion productivity can be improved.

### DESCRIPTION OF THE PREFERRED EMBODIMENTS

Hereinbelow, the present invention will be described in detail.

(Polyolefin Wax (B))

The polyolefin wax (B) used in the present invention is an ethylene homopolymer, or a copolymer of ethylene and an α-olefin having 3 to 20 carbon atoms.

The α-olefin as used herein is preferably an α-olefin having 3 to 10 carbon atoms, and the α-olefin is more preferably propylene having 3 carbon atoms, 1-butene having 4 carbon atoms, 1-pentene having 5 carbon atoms, 1-hexene and 4-methyl-1-pentene having 6 carbon atoms, 1-octene having 8 carbon atoms, or the like, and particularly preferably propylene, 1-butene, 1-hexene, or 4-methyl-1-pentene.

The polyolefin wax (B) has a number-average molecular weight (Mn) in terms of polyethylene, as measured by gel permeation chromatography (GPC), in the range of usually 400 to 5,000, preferably 1,000 to 4,000, more preferably 1,500 to 4,000.

The ratio (Mw/Mn) of the weight-average molecular weight (Mw) to the number-average molecular weight (Mn) in terms of polyethylene, as measured by gel permeation chromatography (GPC), is in the range of usually 1.1 to 3.5, preferably 1.2 to 3.0, and more preferably 1.2 to 2.5.

The polyolefin wax (B) has a melting point, as measured by a differential scanning calorimetry (DSC), preferably in the range of 65 to 130° C., more preferably in the range of 70 to 120° C., and particularly preferably in the range of 80 to 110° C.

The polyolefin wax (B) has a density, as measured by a density gradient tube process, in the range of 850 to 980 kg/m³, preferably 870 to 950 kg/m³, and more preferably 870 to 930 kg/m³.

With respect to the polyolefin wax (B), the relationship between the crystallization temperature (Tc (° C.), measured at a temperature lowering rate of 2° C./min.), as measured by a differential scanning calorimetry (DSC), and the density (D (kg/m³)), as measured by a density gradient tube process satisfies the following formula (I):
0.501×D−366≧Tc (I),
preferably the following formula (II):
0.501×D−366.5≧Tc (Ia),
and
more preferably the following formula (III):
0.501×D−367≧Tc (Ib).

When the crystallization temperature (Tc) and the density (D) of the polyolefin wax (B) satisfies the above formula, the compositional distribution of the comonomers of the polyolefin wax (B) is uniform, and as a result, the content of the tacky components of the polyolefin wax (B) is decreased, and the tackiness of the thermoplastic resin composition comprising the polyolefin wax (B) tends to be reduced.

The penetration hardness of the polyolefin wax (B) is usually 30 dmm or less, preferably 25 dmm or less, more preferably 20 dmm or less, even more preferably 15 dmm or less. The penetration hardness can be measured in accordance with JIS K2207.

The polyolefin wax (B) has an acetone extraction quantity in the range of preferably 0 to 20% by weight, and more preferably 0 to 15% by weight.

The acetone extraction quantity is measured by the following manner.

200 ml of acetone is introduced into a round-bottom flask (300 ml) in the lower part of a Soxhlet's extractor (made of glass) through a filter (ADVANCE, No. 84). Extraction is carried out in a hot-water bath at 70° C. for 5 hours. 10 g of the first wax is set on the filter.

The polyolefin wax (B) is a solid at room temperature, and is a low-viscosity liquid at 65 to 130° C.

The polyolefin wax (B) as described above can be prepared using a metallocene catalyst comprising a metallocene compound of a transition metal selected from Group 4 of the periodic table, and an organoaluminum oxy-compound and/or an ionizing ionic compound.

(Metallocene Compound)

The metallocene compound for forming the metallocene catalyst is a metallocene compound of a transition metal selected from Group 4 of the periodic table, and a specific example thereof is a compound represented by the following formula (1):
M¹Lₓ (1)

In the above formula, M¹ is a transition metal selected from Group 4 of the periodic table, x is a valence of the transition metal M¹, and L is a ligand. Examples of the transition metals indicated by M¹ include zirconium, titanium and hafnium. L is a ligand coordinated to the transition metal M¹, and at least one ligand L is a ligand having cyclopentadienyl skeleton. This ligand having cyclopentadienyl skeleton may have a substituent. Examples of the ligands L having cyclopentadienyl skeleton include a cyclopentadienyl group, alkyl or cycloalkyl substituted cyclopentadienyl groups, such as methylcyclopentadienyl, ethylcyclopentadienyl, n- or i-propylcyclopentadienyl, n-, i-, sec-, or t-butylcyclopentadienyl, dimethylcyclopentadienyl, methylpropylcyclopentadienyl, methylbutylcyclopentadienyl and methylbenzylcyclopentadienyl, an indenyl group, a 4,5,6,7-tetrahydroindenyl group and a fluorenyl group. In these ligands having cyclopentadienyl skeleton, hydrogen may be replaced with a halogen atom, a trialkylsilyl group or the like.

When the metallocene compound has two or more ligands having cyclopentadienyl skeleton as ligands L, two of the ligands having cyclopentadienyl skeleton may be bonded to each other through an alkylene group, such as ethylene or propylene, a substituted alkylene group, such as isopropylidene or diphenylmethylene, a silylene group, or a substituted silylene group, such as dimethylsilylene, diphenylsilylene or methylphenylsilylene.

The ligand L other than the ligand having cyclopentadienyl skeleton (ligand having no cyclopentadienyl skeleton) is, for example, a hydrocarbon group of 1 to 12 carbon atoms, an alkoxy group, an aryloxy group, a sulfonic acid-containing group (—SO₃R¹), wherein R¹ is an alkyl group, an alkyl group substituted with a halogen atom, an aryl group, an aryl group substituted with a halogen atom, or an aryl group substituted with an alkyl group, a halogen atom or a hydrogen atom.

### Example 1 of Metallocene Compound

When the metallocene compound represented by the above formula (1) has a transition metal valence of, for example, 4, this metallocene compound is more specifically represented by the following formula (2):
R²ₖR³ₗR⁴ₘR⁵ₙM¹ (2)

wherein M¹ is a transition metal selected from Group 4 of the periodic table, R² is a group (ligand) having cyclopentadienyl skeleton, and R³, R⁴ and R⁵ are each independently a group (ligand) having or not having cyclopentadienyl skeleton, k is an integer of 1 or greater, and k+1+m+n=4.

Examples of the metallocene compounds having zirconium as M¹ and having at least two ligands having cyclopentadienyl skeleton include bis(cyclopentadienyl)zirconium monochloride monohydride, bis(cyclopentadienyl)zirconium dichloride, bis(1-methyl-3-butylcyclopentadienyl)zirconium-bis(trifluoromethanesulfonate) and bis(1,3-dimethylcyclopentadienyl)zirconium dichloride.

Also employable are compounds wherein the 1,3-position substituted cyclopentadienyl group in the above compounds is replaced with a 1,2-position substituted cyclopentadienyl group. As another example of the metallocene compound, a metallocene compound of bridge type wherein at least two of R², R³, R⁴ and R⁵ in the formula (2), e.g., R² and R³, are groups (ligands) having cyclopentadienyl skeleton and these at least two groups are bonded to each other through an alkylene group, a substituted alkylene group, a silylene group, a substituted silylene group or the like is also employable. In this case, R⁴ and R⁵ are each independently the same as the aforesaid ligand L other than the ligand having cyclopentadienyl skeleton.

Examples of the metallocene compounds of bridge type include ethylenebis(indenyl)dimethylzirconium, ethylenebis(indenyl)zirconium dichloride, isopropylidene(cyclopentadienyl-fluorenyl)zirconium dichloride, diphenylsilylenebis(indenyl)zirconium dichloride and methylphenylsilylenebis(indenyl)zirconium dichloride.

### Example 2 of Metallocene Compound

Another example of the metallocene compound is a metallocene compound represented by the following formula (3) that is described in JP-A No. 4-268307.

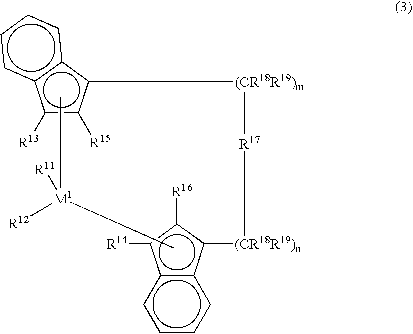

In the above formula, M¹ is a transition metal of Group 4 of the periodic table, specifically titanium, zirconium or hafnium.

R¹¹ and R¹² may be the same as or different from each other and are each a hydrogen atom, an alkyl group of 1 to 10 carbon atoms, an alkoxy group of 1 to 10 carbon atoms, an aryl group of 6 to 10 carbon atoms, an aryloxy group of 6 to 10 carbon atoms, an alkenyl group of 2 to 10 carbon atoms, an arylalkyl group of 7 to 40 carbon atoms, an alkylaryl group of 7 to 40 carbon atoms, an arylalkenyl group of 8 to 40 carbon atoms or a halogen atom. R¹¹ and R¹² are each preferably a chlorine atom.

R¹³ and R¹⁴ may be the same as or different from each other and are each a hydrogen atom, a halogen atom, an alkyl group of 1 to 10 carbon atoms which may be halogenated, an aryl group of 6 to 10 carbon atoms, or a group of —N(R²⁰)₂, —SR²⁰, —OSi(R²⁰)₃, —Si(R²⁰)₃ or —P(R²⁰)₂. R²⁰ is a halogen atom, preferably a chlorine atom, an alkyl group of 1 to 10 carbon atoms (preferably 1 to 3 carbon atoms) or an aryl group of 6 to 10 carbon atoms (preferably 6 to 8 carbon atoms). R¹³ and R¹⁴ are each particularly preferably a hydrogen atom.

R¹⁵ and R¹⁶ are the same as R¹³ and R¹⁴, except that a hydrogen atom is not included, and they may be the same as or different from each other, preferably the same as each other. R¹⁵ and R¹⁶ are each preferably an alkyl group of 1 to 4 carbon atoms which may be halogenated, specifically methyl, ethyl, propyl, isopropyl, butyl, isobutyl, trifluoromethyl or the like, particularly preferably methyl.

In the formula (3), R¹⁷ is selected from the following group:

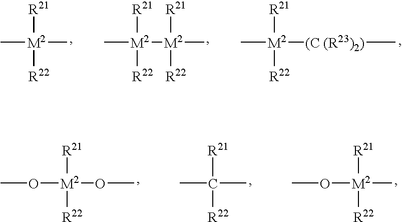

═BR²¹, ═AlR²¹, —Ge—, —Sn—, —O—, —S—, ═SO, ═SO₂, ═NR²¹, ═CO, ═PR²¹, ═P(O)R²¹, etc. M² is silicon, germanium or tin, preferably silicon or germanium. R²¹, R²² and R²³ may be the same as or different from one another and are each a hydrogen atom, a halogen atom, an alkyl group of 1 to 10 carbon atoms, a fluoroalkyl group of 1 to 10 carbon atoms, an aryl group of 6 to 10 carbon atom, a fluoroaryl group of 6 to 10 carbon atoms, an alkoxy group of 1 to 10 carbon atoms, an alkenyl group of 2 to 10 carbon atoms, an arylalkyl group of 7 to 40 carbon atoms, an arylalkenyl group of 8 to 40 carbon atoms, or an alkylaryl group of 7 to 40 carbon atoms. “R²¹ and R²²” or “R²¹ and R²³” may form a ring together with atoms to which they are bonded. R¹⁷ is preferably ═CR²¹R²², ═SiR²¹R²², ═GeR²¹R²², —O—, —S—, ═SO, ═PR²¹ or ═P(O)R²¹. R¹⁸ and R¹⁹ may be the same as or different from each other and are each the same atom or group as that of R²¹. m and n may be the same as or different from each other and are each 0, 1 or 2, preferably 0 or 1, and m+n is 0, 1 or 2, preferably 0 or 1.

Examples of the metallocene compounds represented by the formula (3) include rac-ethylene(2-methyl-1-indenyl)₂-zirconium dichloride and rac-dimethylsilylene (2-methyl-1-indenyl)₂-zirconium dichloride. These metallocene compounds can be prepared by, for example, a process described in JP-A No. 4-268307.

### Example 3 of Metallocene Compound

As the metallocene compound, a metallocene compound represented by the following formula (4) is also employable.

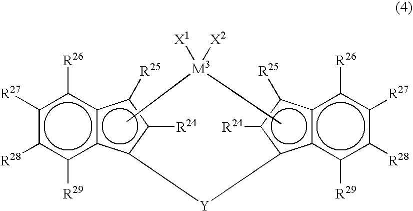

In the formula (4), M³ is a transition metal atom of Group 4 of the periodic table, specifically titanium, zirconium or hafnium. R²⁴ and R²⁵ may be the same as or different from each other and are each a hydrogen atom, a halogen atom, a hydrocarbon group of 1 to 20 carbon atoms, a halogenated hydrocarbon group of 1 to 20 carbon atoms, a silicon-containing group, an oxygen-containing group, a sulfur-containing group, a nitrogen-containing group or a phosphorus-containing group. R²⁴ is preferably a hydrocarbon group, particularly preferably an alkyl group of 1 to 3 carbon atoms, i.e., methyl, ethyl or propyl. R²⁵ is preferably a hydrogen atom or hydrocarbon group, particularly preferably a hydrogen atom or an alkyl group of 1 to 3 carbon atoms, i.e., methyl, ethyl or propyl. R²⁶, R²⁷, R²⁸ and R²⁹ may be the same as or different from one another and are each a hydrogen atom, a halogen atom, a hydrocarbon group of 1 to 20 carbon atoms or a halogenated hydrocarbon group of 1 to 20 carbon atoms. Of these, preferable is a hydrogen atom, a hydrocarbon group or a halogenated hydrocarbon group. At least one combination of R²⁶ and R²⁷, R²⁷ and R²⁸, and R²⁸ and R²⁹ may form a monocyclic aromatic ring together with carbon atoms to which they are bonded. When there are two or more hydrocarbon groups or halogenated hydrocarbon groups other than the groups that form the aromatic ring, they may be bonded to each other to form a ring. When R²⁹ is a substituent other than the aromatic group, it is preferably a hydrogen atom. X¹ and X² may be the same as or different from each other and are each a hydrogen atom, a halogen atom, a hydrocarbon group of 1 to 20 carbon atoms, a halogenated hydrocarbon group of 1 to 20 carbon atoms, an oxygen-containing group or a sulfur-containing group. Y is a divalent hydrocarbon group of 1 to 20 carbon atoms, a divalent halogenated hydrocarbon group of 1 to 20 carbon atoms, a divalent silicon-containing group, a divalent germanium-containing group, a divalent tin-containing group, —O—, —CO—, —S—, —SO—, —SO₂—, —NR³⁰—, —P(R³⁰)—, —P(O)(R³⁰)—, —BR³⁰— or —AlR³⁰— (R³⁰ is a hydrogen atom, a halogen atom, a hydrocarbon group of 1 to 20 carbon atoms or a halogenated hydrocarbon group of 1 to 20 carbon atoms).

In the formula (4), examples of the ligands which have a monocyclic aromatic ring formed by mutual bonding of at least one combination of R²⁶ and R²⁷, R²⁷, and R²⁸, and R²⁸ and R²⁹ and which are coordinated to M³ include those represented by the following formulas:

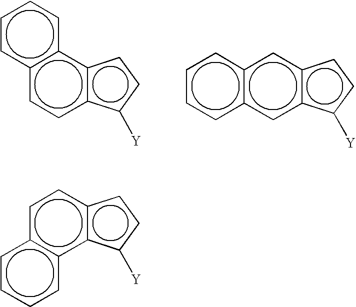

(wherein Y is the same as that described in the above-mentioned formula).

### Example 4 of Metallocene Compound

As the metallocene compound, a metallocene compound represented by the following formula (5) is also employable.

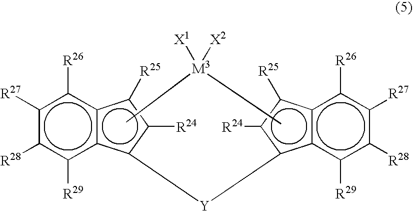

In the formula (5), M³ , R²⁴, R²⁵, R²⁶, R²⁷, R²⁸ and R²⁹ are the same as those in the formula (4). Of R²⁶, R²⁷, R²⁸ and R²⁹, two groups including R²⁶ are each preferably an alkyl group, and R²⁶ and R²⁸, or R²⁸ and R²⁹ are each preferably an alkyl group. This alkyl group is preferably a secondary or tertiary alkyl group. Further, this alkyl group may be substituted with a halogen atom or a silicon-containing group. Examples of the halogen atoms and the silicon-containing groups include substituents exemplified with respect to R²⁴ and R²⁵. Of R²⁶, R²⁷, R²⁸ and R²⁹, groups other than the alkyl group are each preferably a hydrogen atom. Two groups selected from R²⁶, R²⁷, R²⁸ and R²⁹ may be bonded to each other to form a monocycle or a polycycle other than the aromatic ring. Examples of the halogen atoms include the same atoms as described with respect to R²⁴ and R²⁵. Examples of X¹, X² and Y include the same atoms and groups as previously described.

Examples of the metallocene compounds represented by the formula (5) include:

rac-dimethylsilylene-bis(4,7-dimethyl-1-indenyl)zirconium dichloride, rac-dimethylsilylene-bis(2,4,7-trimethyl-1-indenyl)zirconium dichloride and rac-dimethylsilylene-bis(2,4,6-trimethyl-1-indenyl)zirconium dichloride.

Also employable are transition metal compounds wherein the zirconium metal is replaced with a titanium metal or a hafnium metal in the above compounds. The transition metal compound is usually used as a racemic modification, but R form or S form is also employable.

### Example 5 of Metallocene Compound

As the metallocene compound, a metallocene compound represented by the following formula (6) is also employable.

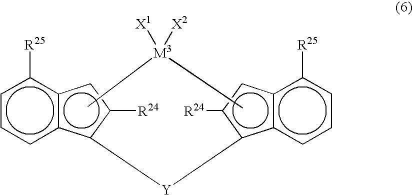

In the formula (6), M³, R²⁴, X¹, X² and Y are the same as those in the formula (4). R²⁴ is preferably a hydrocarbon group, particularly preferably an alkyl group of 1 to 4 carbon atoms, i.e., methyl, ethyl, propyl or butyl. R²⁵ is an aryl group of 6 to 16 carbon atoms. R²⁵ is preferably phenyl or naphthyl. The aryl group may be substituted with a halogen atom, a hydrocarbon group of 1 to 20 carbon atoms or a halogenated hydrocarbon group of 1 to 20 carbon atom. X¹ and X² are each preferably a halogen atom or a hydrocarbon group of 1 to 20 carbon atoms.

Examples of the metallocene compounds represented by the formula (6) include:

rac-dimethylsilylene-bis(4-phenyl-1-indenyl)zirconium dichloride, rac-dimethylsilylene-bis(2-methyl-4-phenyl-1-indenyl)zirconium dichloride, rac-dimethylsilylene-bis(2-methyl-4-(α-naphthyl)-1-indenyl)zirconium dichloride, rac-dimethylsilylene-bis(2-methyl-4-(β-naphthyl)-1-indenyl)zirconium dichloride and rac-dimethylsilylene-bis(2-methyl-4-(1-anthryl)-1-indenyl)zirconium dichloride. Also employable are transition metal compounds wherein the zirconium metal is replaced with a titanium metal or a hafnium metal in the above compounds.

### Example 6 of Metallocene Compound

As the metallocene compound, a metallocene compound represented by the following formula (7) is also employable.
LaM⁴X³₂ (7)

In the above formula, M⁴ is a metal of Group 4 or lanthanide series of the periodic table. La is a derivative of a delocalized π bond group and is a group imparting a constraint geometric shape to the metal M⁴ active site. Each X³ may be the same or different and is a hydrogen atom, a halogen atom, a hydrocarbon group of 20 or less carbon atoms, a silyl group having 20 or less silicon atoms or a germyl group having 20 or less germanium atoms.

Of such compounds, a compound represented by the following formula (8) is preferable.

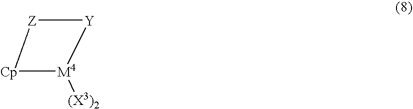

In the formula (8), M⁴ is titanium, zirconium or hafnium. X³ is the same as that described in the formula (7). Cp is π-bonded to M⁴ and is a substituted cyclopentadienyl group having a substituent Z. Z is oxygen, sulfur, boron or an element of Group 4 of the periodic table (e.g., silicon, germanium or tin). Y is a ligand having nitrogen, phosphorus, oxygen or sulfur, and Z and Y may together form a condensed ring. Examples of the metallocene compounds represented by the formula (8) include:

(dimethyl(t-butylamide)(tetramethyl-η⁵-cyclopentadienyl)silane)titanium dichloride and ((t-butylamide)(tetramethyl-η⁵-cyclopentadienyl)-1,2-ethanediyl)titanium dichloride. Also employable are metallocene compounds wherein titanium is replaced with zirconium or hafnium in the above compounds.

### Example 7 of Metallocene Compound

As the metallocene compound, a metallocene compound represented by the following formula (9) is also employable.

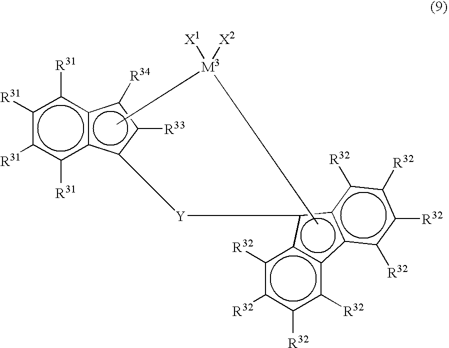

In the formula (9), M³ is a transition metal atom of Group 4 of the periodic table, specifically titanium, zirconium or hafnium, preferably zirconium. Each R³¹ may be the same or different, and at least one of them is an aryl group of 11 to 20 carbon atoms, an arylalkyl group of 12 to 40 carbon atoms, an arylalkenyl group of 13 to 40 carbon atoms, an alkylaryl group of 12 to 40 carbon atoms or a silicon-containing group, or at least two neighboring groups of the groups indicated by R³¹ form single or plural aromatic rings or aliphatic rings together with carbon atoms to which they are bonded. In this case, the ring formed by R³¹ has 4 to 20 carbon atoms in all including carbon atoms to which R³¹ is bonded. R³¹ other than R³¹ that is an aryl group, an arylalkyl group, an arylalkenyl group or an alkylaryl group or that forms an aromatic ring or an aliphatic ring is a hydrogen atom, a halogen atom, an alkyl group of 1 to 10 carbon atoms or a silicon-containing group. Each R³² may be the same or different and is a hydrogen atom, a halogen atom, an alkyl group of 1 to 10 carbon atoms, an aryl group of 6 to 20 carbon atoms, an alkenyl group of 2 to 10 carbon atoms, an arylalkyl group of 7 to 40 carbon atoms, an arylalkenyl group of 8 to 40 carbon atoms, an alkylaryl group of 7 to 40 carbon atoms, a silicon-containing group, an oxygen-containing group, a sulfur-containing group, a nitrogen-containing group or a phosphorus-containing group. At least two neighboring groups of the groups indicated by R³² may form single or plural aromatic rings or aliphatic rings together with carbon atoms to which they are bonded. In this case, the ring formed by R³² has 4 to 20 carbon atoms in all including carbon atoms to which R³² is bonded. R³² other than R³² that forms an aromatic ring or an aliphatic ring is a hydrogen atom, a halogen atom, an alkyl group of 1 to 10 carbon atoms or a silicon-containing group. In the groups constituted of single or plural aromatic rings or aliphatic rings formed by two groups indicated by R³², an embodiment wherein the fluorenyl group part has such a structure as represented by the following formula is included.

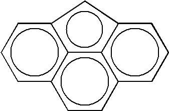

R³² is preferably a hydrogen atom or an alkyl group, particularly preferably a hydrogen atom or a hydrocarbon group of 1 to 3 carbon atoms, i.e., methyl, ethyl or propyl. A preferred example of the fluorenyl group having R³² as such a substituent is a 2,7-dialkyl-fluorenyl group, and in this case, an alkyl group of the 2,7-dialkyl is, for example, an alkyl group of 1 to 5 carbon atoms. R³¹ and R³² may be the same as or different from each other. R³³ and R³⁴ may be the same as or different from each other and are each a hydrogen atom, a halogen atom, an alkyl group of 1 to 10 carbon atoms, an aryl group of 6 to 20 carbon atoms, an alkenyl group of 2 to 10 carbon atoms, an arylalkyl group of 7 to 40 carbon atoms, and arylalkenyl group of 8 to 40 carbon atoms, an alkylaryl group of 7 to 40 carbon atoms, a silicon-containing group, an oxygen-containing group, a sulfur-containing group, a nitrogen-containing group or a phosphorus-containing group, similarly to the above. At least one of R³³ and R³⁴ is preferably an alkyl group of 1 to 3 carbon atoms. X¹ and X² may be the same as or different from each other and are each a hydrogen atom, a halogen atom, a hydrocarbon group of 1 to 20 carbon atoms, a halogenated hydrocarbon group of 1 to 20 carbon atoms, an oxygen-containing group, a sulfur-containing group or a nitrogen-containing group, or X¹ and X² form a conjugated diene residue. Preferred examples of the conjugated diene residues formed from X¹ and X² include residues of 1,3-butadiene, 2,4-hexadiene, 1-phenyl-1,3-pentadiene and 1,4-diphenylbutadiene, and these residues may be further substituted with a hydrocarbon group of 1 to 10 carbon atoms. X¹ and X² are each preferably a halogen atom, a hydrocarbon group of 1 to 20 carbon atoms or a sulfur-containing group. Y is a divalent hydrocarbon group of 1 to 20 carbon atoms, a divalent halogenated hydrocarbon group of 1 to 20 carbon atoms, a divalent silicon-containing group, a divalent germanium-containing group, a divalent tin-containing group, —O—, —CO—, —S—, —SO—, —SO₂—, —NR³⁵—, —P(R³⁵)—, —P(O)(R³⁵)—, —BR³⁵— or —AlR³⁵— (R³⁵ is a hydrogen atom, a halogen atom, a hydrocarbon group of 1 to 20 carbon atoms or a halogenated hydrocarbon group of 1 to 20 carbon atoms). Of these divalent groups, preferable are those wherein the shortest linkage part of-Y-is constituted of one or two atoms. R³⁵ is a halogen atom, a hydrocarbon group of 1 to 20 carbon atoms or a halogenated hydrocarbon group of 1 to 20 carbon atoms. Y is preferably a divalent hydrocarbon group of 1 to 5 carbon atoms, a divalent silicon-containing group or a divalent germanium-containing group, more preferably a divalent silicon-containing group, particularly preferably alkylsilylene, alkylarylsilylene or arylsilylene.

### Example 8 of Metallocene Compound

As the metallocene compound, a metallocene compound represented by the following formula (10) is also employable.

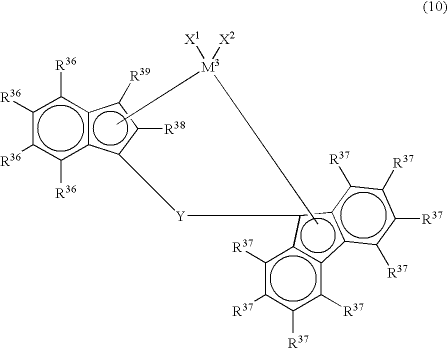

In the formula (10), M³ is a transition metal atom of Group 4 of the periodic table, specifically titanium, zirconium or hafnium, preferably zirconium. Each R³⁶ may be the same or different and is a hydrogen atom, a halogen atom, an alkyl group of 1 to 10 carbon atoms, an aryl group of 6 to 10 carbon atoms, an alkenyl group of 2 to 10 carbon atoms, a silicon-containing group, an oxygen-containing group, a sulfur-containing group, a nitrogen-containing group or a phosphorus-containing group. The alkyl group and the alkenyl group may be substituted with a halogen atom. R³⁶ is preferably an alkyl group, an aryl group or a hydrogen atom, particularly preferably a hydrocarbon group of 1 to 3 carbon atoms, i.e., methyl, ethyl, n-propyl or i-propyl, an aryl group, such as phenyl, α-naphthyl or β-naphthyl, or a hydrogen atom. Each R³⁷ may be the same or different and is a hydrogen atom, a halogen atom, an alkyl group of 1 to 10 carbon atoms, an aryl group of 6 to 20 carbon atoms, an alkenyl group of 2 to 10 carbon atoms, an arylalkyl group of 7 to 40 carbon atoms, an arylalkenyl group of 8 to 40 carbon atoms, an alkylaryl group of 7 to 40 carbon atoms, a silicon-containing group, an oxygen-containing group, a sulfur-containing group, a nitrogen-containing group or a phosphorus-containing group. The alkyl group, the aryl group, the alkenyl group, the arylalkyl group, the arylalkenyl group and the alkylaryl group may be substituted with halogen. R³⁷ is preferably a hydrogen atom or an alkyl group, particularly preferably a hydrogen atom or a hydrocarbon group of 1 to 4 carbon atoms, i.e., methyl, ethyl, n-propyl, i-propyl, n-butyl or tert-butyl. R³⁶ and R³⁷ may be the same as or different from each other. One of R³⁸ and R³⁹ is an alkyl group of 1 to 5 carbon atoms, and the other is a hydrogen atom, a halogen atom, an alkyl group of 1 to 10 carbon atoms, an alkenyl group of 2 to 10 carbon atoms, a silicon-containing group, an oxygen-containing group, a sulfur-containing group, a nitrogen-containing group or a phosphorus-containing group. It is preferable that one of R³⁸ and R³⁹ is an alkyl group of 1 to 3 carbon atoms, such as methyl, ethyl or propyl, and the other is a hydrogen atom. X¹ and X² may be the same as or different from each other and are each a hydrogen atom, a halogen atom, a hydrocarbon group of 1 to 20 carbon atoms, a halogenated hydrocarbon group of 1 to 20 carbon atoms, an oxygen-containing group, a sulfur-containing group or a nitrogen-containing group, or X¹ and X^{z} form a conjugated diene residue. X¹ and X² are each preferably a halogen atom or a hydrocarbon group of 1 to 20 carbon atoms. Y is a divalent hydrocarbon group of 1 to 20 carbon atoms, a divalent halogenated hydrocarbon group of 1 to 20 carbon atoms, a divalent silicon-containing group, a divalent germanium-containing group, a divalent tin-containing group, —O—, —Co—, —S—, —SO—, —SO₂—, —NR⁴⁰—, P(R⁴⁰)—, —P(O)(R⁴⁰)—, —BR⁴⁰— or —AlR⁴⁰— (R⁴⁰ is a hydrogen atom, a halogen atom, a hydrocarbon group of 1 to 20 carbon atoms or a halogenated hydrocarbon group of 1 to 20 carbon atoms). Y is preferably a divalent hydrocarbon group of 1 to 5 carbon atoms, a divalent silicon-containing group or a divalent germanium-containing group, more preferably a divalent silicon-containing group, particularly preferably alkylsilylene, alkylarylsilylene or arylsilylene.

The metallocene compounds described above are used singly or in combination of two or more kinds. The metallocene compounds may be used after diluted with hydrocarbon, halogenated hydrocarbon or the like.

(Organoaluminum Oxy-Compound)

The organoaluminum oxy-compound may be aluminoxane publicly known or a benzene-insoluble organoaluminum oxy-compound. Such publicly known aluminoxane is represented by the following formulas:

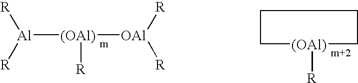

In the above formulas, R is a hydrocarbon group, such as a methyl group, an ethyl group, a propyl group and a butyl group, preferably a methyl group and an ethyl group, particularly preferably a methyl group. m is an integer of 2 or greater, preferably 5 to 40.

The aluminoxane may be constituted of mixed alkyloxyaluminum units comprising an alkyloxyaluminum unit represented by the formula (OAl(R′)) and an alkyloxyaluminum unit represented by the formula (OAl(R″)) (examples of R′ and R″ include the same hydrocarbon groups as described with respect to R, and R′ and R″ are groups different from each other). The organoaluminum oxy-compound may contain a small amount of an organic compound component of a metal other than aluminum.

(Ionizing Ionic Compound)

The ionizing ionic compound (sometimes referred to as an “ionic ionizing compound” or an “ionic compound”) is, for example, Lewis acid, an ionic compound, a borane compound or a carborane compound. The Lewis acid is, for example, a compound represented by BR₃ (R is a phenyl group which may have a substituent, such as fluorine, methyl or trifluoromethyl, or a fluorine atom). Examples of the Lewis acids include trifluoroboron, triphenylboron, tris(4-fluorophenyl)boron, tris(3,5-difluorophenyl)boron, tris(4-fluoromethylphenyl)boron, tris(pentafluorophenyl)boron, tris(p-tolyl)boron, tris(o-tolyl)boron and tris(3,5-dimethylphenyl)boron.

Examples of the ionic compounds include trialkyl substituted ammonium salts, N,N-dialkylanilinium salts, dialkylammonium salts and triarylphosphonium salts. Examples of the trialkyl substituted ammonium salts as the ionic compounds include triethylammonium tetra(phenyl)boron, tripropylammonium tetra(phenyl)boron and tri(n-butyl)ammonium tetra(phenyl)boron. Examples of the dialkylammonium salts as the ionic compounds include di(1-propyl)ammonium tetra(pentafluorophenyl)boron and dicyclohexylammonium tetra(phenyl)boron.

Also employable as the ionic compounds are triphenylcarbenium tetrakis(pentafluorophenyl)borate, N,N-dimethylanilinium tetrakis(pentafluorophenyl)borate and ferrocenium tetra(pentafluorophenyl)borate.

Examples of the borane compounds include decaborane (9), bis[tri(n-butyl)ammonium]nonaborate, bis[tri(n-butyl)ammonium]decaborate and salts of metallic borane anions, such as bis[tri(n-butyl)ammonium]bis(dodecahydridododecaborato)nickelate (III).

Examples of the carborane compounds include 4-carbanonaborane (9), 1,3-dicarbanonaborane (8), and salts of metallic carborane anions, such as bis[tri(n-butyl)ammonium]bis(undecahydrido-7-carbaundecaborato)nickelate (IV).

The ionizing ionic compounds described above are used singly or in combination of two or more kinds.

For forming the metallocene catalyst, such an organoaluminum compound as described below may be used together with the organoaluminum oxy-compound and/or the ionizing ionic compound.

(Organoaluminum Compound)

As the organoaluminum compound that is used when need, a compound having at least one Al-carbon bond in a molecule is employable. Examples of such compounds include:

an oragnoaluminum compound represented by the following formula (11):
(R⁶)ₘAl(OR⁷)ₙHₚX⁴_{q} (11)

wherein R⁶ and R⁷ may be the same as or different from each other and are each a hydrocarbon group of usually 1 to 15 carbon atoms, preferably 1 to 4 carbon atoms, X⁴ is a halogen atom, and m, n, p and q are numbers satisfying the conditions of 0≦m<3, 0≦n<3, 0≦p<3, 0≦q<3 and m+n+p+q=3, and

an alkyl complex compound of a Group 1 metal and aluminum, which is represented by the following formula (12):
(M⁵ )Al(R⁶) (12)

wherein M⁵ is Li, Na or K, and R⁶ is the same as R⁶ in the formula (11).

(Polymerization)

The polyolefin wax (B) used in the present invention is obtained by homopolymerizing ethylene usually in a liquid phase or copolymerizing ethylene and an α-olefin, in the presence of the above-mentioned metallocene catalyst. Herein, a hydrocarbon solvent is generally used, but an α-olefin may be used as a solvent. The monomers used herein are as previously described.

As the polymerization process, suspension polymerization wherein polymerization is carried out in such a state that the polyolefin wax (B) is present as particles in a solvent such as hexane, or gas phase polymerization wherein polymerization is carried out without a solvent, or solution polymerization wherein polymerization is carried out at a polymerization temperature of not lower than 140° C. in such a state that the polyolefin wax (B) is molten in the presence of a solvent or is molten alone is employable. Of these, solution polymerization is preferable in both aspects of economy and quality.

The polymerization reaction may be carried out by any of a batch process and a continuous process. When the polymerization is carried out by a batch process, the aforesaid catalyst components are used in the concentrations described below. The concentration of the metallocene compound in the polymerization system is in the range of usually 0.00005 to 0.1 mmol/liter (polymerization volume), preferably 0.0001 to 0.05 mmol/liter.

The organoaluminum oxy-compound is fed in such an amount that the molar ratio of an aluminum atom to the transition metal of the metallocene compound in the polymerization system (Al/transition metal) is in the range of 1 to 10000, preferably 10 to 5000.

The ionizing ionic compound is fed in such an amount that the molar ratio of the ionizing ionic compound to the metallocene compound in the polymerization system (ionizing ionic compound/metallocene compound) is in the range of 0.5 to 20, preferably 1 to 10.

When the organoaluminum compound is used, the amount of the organoaluminum compound is in the range of usually about 0 to 5 mmol/liter (polymerization volume), preferably about 0 to 2 mmol/liter.

The polymerization reaction is carried out under the conditions of a temperature of usually −20 to +200° C., preferably 50 to 180° C., more preferably 70 to 180° C., and a pressure of more than 0 and not more than 7.8 MPa (80 kgf/cm², gauge pressure), preferably more than 0 and not more than 4.9 MPa (50 kgf/cm², gauge pressure).

In the polymerization, ethylene and an α-olefin that is used when needed are fed to the polymerization system in such amounts that a polyolefin wax (B) of the aforesaid specific composition is obtained. In the polymerization, further, a molecular weight modifier such as hydrogen can be added.

When polymerization is carried out in this manner, a polymer produced is usually obtained in a form of a polymerization solution containing the polymer. Therefore, by treating the polymerization solution in the usual way, a polyethylene wax is obtained.

In the polymerization reaction, it is particularly preferable to use a catalyst containing the metallocene compound described in “Example 6 of metallocene compound”.

(Thermoplastic Resin (A))

The thermoplastic resin (A) in the present invention can be selected from a polyolefin resin such as a low-density polyethylene, a medium-density polyethylene, a high-density polyethylene, a linear low-density polyethylene, polypropylene, and an ethylene-propylene copolymer; an olefin-vinyl compound copolymer such as an ethylene-acrylic acid copolymer, an ethylene-methacrylic acid copolymer, and an esterified product thereof, an ethylene-vinyl acetate copolymer, and an ethylene-vinyl alcohol copolymer; a polyvinyl resin; a polystyrene resin; a polyester resin such as polyethylene terephthalate; and a polyamide resin. Further, a graft copolymer, a block copolymer or a random copolymer thereof can be used as a thermoplastic resin (A). In addition, these resins can be used in a blend.

The thermoplastic resin composition of the present invention comprises 100 parts by weight of the thermoplastic resin (A), and 0.1 to 20 parts by weight, preferably 0.1 to 10 parts by weight of the polyolefin wax (B).

The methods for preparing the resin composition containing the thermoplastic resin (A) and the polyolefin wax (B) are not particularly limited, but various mixing devices which are generally used for a thermoplastic resin, for example, a high speed mixer such as Henschel mixer used for usually blending resins, a mixing device such as a tumbler and a pelletizer, and other various mixing devices such as an extruder, a plast mill, a kneader, a roll miller, a Banbury mixer, and a Brabender, can be used. Further, for melt-kneading, a known device such as a single-screw extruder, and a twin-screw extruder can be used without particular limitation.

A molded product adapted for various applications can be obtained by subjecting the composition to extrusion molding and foam extrusion molding. Generally, the “extrusion molding” refers to a molding process using a series of devices such as an extruder, a die, a sizing die, a cooling bath, a drawing machine, a winding machine and a cutter. According to the shape of the die and the sizing die, a desired shape of the molded product can be obtained. By means of extrusion molding, a sheet, a film, a pipe, a tube, an odd-shaped product such as a frame and a housing members, a wire coating, a laminate product and the like can be prepared. Usually, the cylinder temperature of the extruder is set at 120° C. to 240° C., and the plasticized resin composition is extruded from the die, and while the extruded product is cooled in the sizing die and the cooling bath and drawn by the drawing machine, it is formed into a desired shape. Herein, using a vacuum sizing, more effective shaping and cooling can be effected.

Further, upon extrusion molding, a foaming agent can be added to the resin composition to perform foam extrusion molding. In the case of foam extrusion, the design of a die and a sizing die should be designed in consideration of the foaming ratio or the like. As the foaming agent for making the foam molded product in the present invention, organic or inorganic chemical foaming agents are preferable. Examples of the chemical foaming agents generally include azodicarbonamide (ADCA), azobisisobutyronitrile (AIBN), N,N′-dinitrosopentamethylenetetramine (DPT), 4,4′-oxybis(benzenesulfonylhydrazide) (OBSH), sodium hydrogen carbonate (baking soda), ammonium carbonate, and the like. These foaming agents may be used in a mixture of two or more kinds. Further, an foaming aid such as a zinc compound, an urea compound, an acidic substance, amines, and the like can be used. In addition, a masterbatch of an expanding agent having improved handleability may be used.

In the case where the thermoplastic resin (A) and the polyolefin wax (B) are blended, if necessary, various stabilizers can be blended.

Examples of the stabilizer include an antioxidant such as hindered phenols, phosphites, and thioethers; a UV absorber such as benzotriazoles and benzophenones; and a light stabilizer such as hindered amines.

In addition to the stabilizer, various colorants, a metallic soap, a plasticizer, or the like can be blended.

Examples of the metallic soap which can be blended include stearates such as magnesium stearate, calcium stearate, barium stearate, and zinc stearate.

Further, within a scope of the purpose of the present invention, if necessary, other additives including a filler such as calcium carbonate, titanium oxide, barium sulfate, talc, clay and carbon black, an anti-aging agent, an antioxidant, a UV absorber, a flame retardant, a colorant, a plasticizer, an antibacterial/antifungal agent, or an oil can be blended. These additives are not particularly limited, but conventional known ones which are usually used in a thermoplastic resin composition are used.

Examples of the flame retardant include halogen compounds which are usually used for flame retarding of an ABS resin or a thermoplastic polyester resin; an inorganic flame retardant such as an antimony compound, and a phosphorus flame retardant. Examples of the halogen compound include halogenated diphenyl ether such as decabromodiphenyl ether and octabromodiphenyl ether; and halogenated polycarbonate.

Examples of the flame retardant include antimony trioxide, antimony tetraoxide, antimony pentoxide, sodium pyroantimonate, and aluminum hydroxide, but are not limited thereto.

The blending ratio of the halogen compounds is 0 to 35 parts by weight, preferably 1 to 30 parts by weight, and the blending ratio of the antimony compound is 0 to 25 parts by weight, preferably 1 to 20 parts by weight, based on 100 parts by weight of (A)+(B).

Examples of the antibacterial/antifungal agent include organic ones such as imidazole, thiazole, nitrile, haloalkyl, and pyridine antibacterial/antifungal agents, and inorganic ones such as silver, zinc, copper, and titanium antibacterial/antifungal agents. Among these, a silver antibacterial/antifungal agent which is stable against heat and has high performance is preferably used. Examples of the silver antibacterial agent include ones having silver, silver ions, silver-complexes, or silver compounds supported on a porous structure such as zeolite, silica gel, zirconium phosphate, calcium phosphate, hydrotalcite, hydroxyapatite, and calcium silicate, or a silver salt of a fatty acid, and a silver salt of phosphoric acid alkyl ester.

Further, as a flame retarding aid for drip prevention, a compound such as tetrafluoroethylene can be added.

For the preparation of the thermoplastic resin composition of the present invention, the method of mixing the individual components are not particularly limited, and all the components may be added at once and then mixed, or sequentially added.

### EXAMPLES

The present invention is further described with reference to the following examples, but it should be construed that the invention is in no way limited to those examples.

In the present invention, the molecular weight and the molecular weight distribution of the wax were determined by means of GPC. Measurement was made using a monodisperse standard polystyrene as a standard under the following condition.

Apparatus: 150C-ALC/GPC, manufactured by Waters Co.

Solvent: o-Dichlorobenzene

Column: Type CM, manufactured by Tosoh Corporation

Flow rate: 1.0 ml/min.

Sample: 0.10% of o-dichlorobenzene solution

Temperature: 140° C.

In the present invention, the melting point was measured by a differential scanning calorimetry (DSC), using DSC-20 (manufactured by Seiko Corporation). The temperature of about 10 mg of a sample was raised from −20° C. to 200° C. at a rate of 10° C./min. to obtain a curve, in which an endothermic peak is assumed as a melting point. Preferably, before this measurement of the elevation of the temperature, the resin was once raised to about 200° C., and maintained at that temperature for 5 min., and then immediately cooled to an ordinary temperature (25° C.) to simplify the thermal history of the resin. Measurement was made using an ordinary method at a heating rate of 10° C./min.

In the present invention, the crystallization temperature was measured at a temperature lowering rate of 2° C./min., in accordance with ASTM D 3417-75.

In the present invention, the density (D, kg/m³) was measured in accordance with JIS K7112-1980 after heating a sample at 150° C. for 1 hour, and keeping it at a thermostat bath at 23°.

Further, in the present invention, the tensile strength of the thermoplastic resin composition after extrusion molding was measured in accordance with JIS-K7113.

(i) Appearance of extrusion molded article

The resin composition was subjected to extrusion molding using a die to a thickness of 2 mm, and the appearance of the molded article was evaluated.

Equal transparency to those without addition of wax: ◯

More turbid than those without addition of wax: Δ

White-turbid: x

(Synthesis of Polyolefin Wax 1)

Using a metallocene catalyst, a polyethylene wax was synthesized in the following manner.

In a stainless-steel autoclave having an inner volume of 200 liters, which had been thoroughly purged with nitrogen, 92 liters of hexane and 8 liters of propylene were introduced, and hydrogen was fed until the pressure became 0.1 MPa (gauge pressure). Subsequently, the temperature in the system was raised to 150° C., and then, 0.3 mmol of triisobutylaluminum, 0.04 mmol of triphenylcarbenium tetrakis(pentafluorophenyl)borate and 0.002 mmol of (t-butylamido)dimethyl(tetramethyl-η⁵-cyclopentadienyl)silanetitanium dichloride (available from Sigma Aldrich Corporation) were forced into the autoclave with ethylene to initiate polymerization. Thereafter, only ethylene was continuously fed to maintain the total pressure at 2.9 MPa (gauge pressure), and polymerization was performed at 150° C. for 20 minutes.

After a small amount of ethanol was added to the system to terminate the polymerization, the unreacted ethylene was purged away. The resulting polymer solution was dried overnight at 100° C. under reduced pressure. As a result, 3500 g of a polyethylene wax (1) having an Mn of 1,800, a density of 897 kg/m³, and a DSC melting point of 82° C. The results are shown in Table 1.

(Synthesis of Polyolefin Wax 2)

Using a metallocene catalyst, a polyethylene wax was synthesized in the following manner.

In a stainless-steel autoclave having an inner volume of 200 liters, which had been thoroughly purged with nitrogen, 93.5 liters of hexane and 6 liter of 1-butene were introduced, and hydrogen was fed until the pressure became 0.1 MPa (gauge pressure). Subsequently, the temperature in the system was raised to 150° C., and then, 0.3 mmol of triisobutylaluminum, 0.04 mmol of triphenylcarbenium tetrakis(pentafluorophenyl)borate and 0.002 mmol of (t-butylamido)dimethyl(tetramethyl-η⁵-cyclopentadienyl)silanetitanium dichloride (available from Sigma Aldrich Corporation) were forced into the autoclave with ethylene to initiate polymerization. Thereafter, only ethylene was continuously fed to maintain the total pressure at 2.9 MPa (gauge pressure), and polymerization was performed at 150° C. for 20 minutes.

After a small amount of ethanol was added to the system to terminate the polymerization, the unreacted ethylene and propylene were purged away. The resulting polymer solution was dried overnight at 100° C. under reduced pressure.

As a result, 3300 g of a polyethylene wax (2) having an Mn of 2,200, a density of 930 kg/m³, and a DSC melting point of 108° C. The results are shown in Table 1.

(Synthesis of Polyolefin Wax 3)

Using a metallocene catalyst, a polyethylene wax was synthesized in the following manner.

In a stainless-steel autoclave having an inner volume of 200 liters, which had been thoroughly purged with nitrogen, 85 liters of hexane and 10 liters of propylene were introduced, and hydrogen was fed until the pressure became 0.3 MPa (gauge pressure). Subsequently, the temperature in the system was raised to 150° C., and then, 0.3 mmol of triisobutylaluminum, 0.04 mmol of triphenylcarbenium tetrakis(pentafluorophenyl)borate and 0.002 mmol of (t-butylamido)dimethyl(tetramethyl-η⁵-cyclopentadienyl)silanetitanium dichloride (available from Sigma Aldrich Corporation) were forced into the autoclave with ethylene to initiate polymerization. Thereafter, only ethylene was continuously fed to maintain the total pressure at 2.9 MPa (gauge pressure), and polymerization was performed at 150° C. for 20 minutes.

After a small amount of ethanol was added to the system to terminate the polymerization, the unreacted ethylene and propylene were purged away. The resulting polymer solution was dried overnight at 100° C. under reduced pressure.

As a result, 3100 g of a polyethylene wax (3) having an Mn of 1,000, a density of 890 kg/m³, and a DSC melting point of 86° C. The results are shown in Table 1.

TABLE 1
Properties of polyethylene waxes

| | | | | | | Value |
|---|---|---|---|---|---|---|
| | | | | | | on the |
| | | | | DSC | DSC | left |
| | | | | melting | crystallization | side of |
| | | | Density | point | temperature | Formula |
| | Mn | Mw | (kg/m³) | (° C.) | (° C.) | (I) |
| Wax 1 | 1800 | 4700 | 897 | 82 | 78 | 83.4 |
| Wax 2 | 2200 | 5900 | 930 | 108 | 97 | 99.9 |
| Wax 3 | 1000 | 1800 | 890 | 86 | 66 | 79.9 |
| 420P | 2000 | 6400 | 930 | 113 | 102 | 99.9 |

### Example 1

70 parts by weight of an ethylene-vinyl acetate copolymer resin (EVAFLEX P2805; manufactured by Du Pont-Mitsui Polychemicals Co., Ltd.), 30 parts by weight of a linear low-density polyethylene resin (Evolue SPO540; manufactured by Mitsui Chemicals, Inc.), and 5 parts by weight of the polyethylene wax (1) were mixed. In a twin-screw extruder PCM-30 (manufactured by Ikegai Tekko Co., Ltd.), the cylinder temperature and the die temperature were set at 180° C., respectively, to prepare a sheet. The resin pressure upon melt-kneading was 47 kg/cm². Further, the tensile yield stress of the thermoplastic resin composition after melt-kneading was 24.0 MPa. The tensile strength was measured in accordance with JIS K6922. The results are shown in Table 2.

### Example 2

Melting-kneading was carried out in the same manner as in Example 1, except that the polyethylene wax (1) was changed to the polyethylene wax (2). The resin pressure upon melt-kneading was 46 kg/cm². Further, the tensile yield stress of the thermoplastic resin composition after melt-kneading was 23.5 MPa. The results are shown in Table 2.

### Example 3

Melting-kneading was carried out in the same manner as in Example 1, except that the polyethylene wax (1) was changed to the polyethylene wax (3). The resin pressure upon melt-kneading was 44 kg/cm². Further, the tensile yield stress of the thermoplastic resin composition after melt-kneading was 23.0 MPa. The results are shown in Table 2.

### Comparative Example 1

70 parts by weight of an ethylene-vinyl acetate copolymer resin (EVAFLEX P2805; manufactured by Du Pont-Mitsui Polychemicals Co., Ltd.), and 30 parts by weight of a linear low-density polyethylene resin (Evolue SPO540; manufactured by Mitsui Chemicals, Inc.) were mixed. In a twin-screw extruder PCM-30 (manufactured by Ikegai Tekko Co., Ltd.), melting-kneading was carried out at 180° C. at a discharge amount of 16 kg/hr to obtain a thermoplastic resin composition. The resin pressure upon melt-kneading was 62 kg/cm². Further, the tensile yield stress of the thermoplastic resin composition after melt-kneading was 24.5 MPa. The results are shown in Table 2.

### Comparative Example 2

Melting-kneading was carried out in the same manner as in Example 1, except that the polyethylene wax (1) was changed to a polyethylene wax (Hi-Wax 420P; manufactured by Mitsui Chemicals, Inc.). The resin pressure upon melt-kneading was 46 kg/cm². Further, the tensile yield stress of the thermoplastic resin composition after melt-kneading was 21.5 MPa. The results are shown in Table 2.

TABLE 2
Results of melt-kneading

| | Ex. No./Comp. Ex. No. | | | | |
|---|---|---|---|---|---|
| | | | | Comp. | Comp. |
| | Ex. 1 | Ex. 2 | Ex. 3 | Ex. 1 | Ex. 2 |
| Pressure of | 47 | 46 | 44 | 62 | 46 |
| resin | | | | | |
| Tensile yield | 24.0 | 23.5 | 23.0 | 24.5 | 21.5 |
| stress | | | | | |
| Appearance | ◯ | ◯ | ◯ | Δ | Δ |
| in extrusion | | | | | |
| molded | | | | | |
| article | | | | | |

### INDUSTRIAL APPLICABILITY

According to the present invention, the load applied on the screw of an extruder can be reduced by adding a specific polyolefin to a thermoplastic resin, and thus extrusion productivity can be improved.

What is claimed is:

1. A thermoplastic resin composition comprising
a thermoplastic resin (A), and
a polyolefin wax (B) having a number-average molecular weight (Mn), as measured by gel permeation chromatography (GPC), in the range of 400 to 5,000, a melting point, as measured by a differential scanning calorimetry (DSC), in the range of 65 to 130° C., and a density, as measured by a density gradient tube process, in the range of 850 to 980 kg/m³, and satisfying the relationship represented by the following formula (I) of the crystallization temperature (Tc(° C.), measured at a temperature lowering rate of 2° C./min.), as measured by a differential scanning calorimetry (DSC), and the density (D (kg/m³))
0.501×D−366≧Tc (I).

2. The thermoplastic resin composition according to claim 1, wherein the polyolefin wax (B) is contained in an amount of 0.1 to 20 parts by weight based on 100 parts by weight of the thermoplastic resin.

3. The thermoplastic resin composition according to claim 1, wherein the thermoplastic resin (A) comprises at least one resin selected from the group consisting of a polyolefin resin, an olefin-vinyl compound copolymer, a polyvinyl resin, a polystyrene resin, a polyester resin and a polyamide resin.

4. The thermoplastic resin composition according to claim 3, wherein the thermoplastic resin (A) is a blend of the resins selected from the group consisting of a polyolefin resin, an olefin-vinyl compound copolymer, a polyvinyl resin, a polystyrene resin, a polyester resin and a polyamide resin.

5. The thermoplastic resin composition according to claim 3, wherein the thermoplastic resin (A) comprises at least on copolymer selected from the group consisting of a graft copolymer, a block copolymer and a random copolymer.

6. The thermoplastic resin composition according to claim 5, wherein the thermoplastic resin (A) is a blend of the copolymers selected from the group consisting of a graft copolymer, a block copolymer and a random copolymer.

7. A molded product obtained by molding the thermoplastic resin composition according to claim 1, which is in the form of a film or a sheet.
